(19) United States
(12) Patent Application Publication
(10) Pub. No.: US 2018/0260376 A1
(43) Pub. Date: Sep. 13, 2018

(54) SYSTEM AND METHOD TO CREATE SEARCHABLE ELECTRONIC DOCUMENTS

(71) Applicant: Platinum Intelligent Data Solutions, LLC, Dallas, TX (US)

(72) Inventors: Sidney NEWBY, Keller, TX (US); Michael CANTRELL, Dallas, TX (US); Aaron James TOLEDO, Dallas, TX (US)

(21) Appl. No.: 15/916,113

(22) Filed: Mar. 8, 2018

Related U.S. Application Data
(60) Provisional application No. 62/468,478, filed on Mar. 8, 2017.

(51) Int. Cl. G06F 17/24; G06F 17/30; G06F 17/22; G06K 9/00

(52) U.S. Cl. CPC G06F 17/248; G06F 17/30011; G06K 2209/01; G06F 17/2247; G06K 9/00469; G06F 17/30253

(57) ABSTRACT

A method including receiving data including first searchable data segments and non-searchable data segments, identifying the non-searchable data segments within the data, determining coordinates for the non-searchable data segments relative to the first searchable data segments, extracting the non-searchable data segments, processing the non-searchable data segments, the processing including converting the non-searchable data segments into second searchable data segments, overlaying the second searchable data segments at the determined coordinates relative to the first searchable data segments and exporting the first searchable data segments and the second searchable data segments.

### CROSS-REFERENCE TO RELATED APPLICATIONS

This patent application claims priority from, and incorporates by reference the entire disclosure of, U.S. Provisional Application No. 62/468,478 filed on Mar. 8, 2017.

### BACKGROUND

### Technical Field

The present disclosure relates generally to searchable electronic documents and more particularly, but not by way of limitation, to systems and methods for creating searchable electronic documents.

### History of Related Art

As technology continues to progress through innovations which allow storage and proliferation of data with more ease and efficiency, and at decreasing prices over time, and as people create and share increasingly larger amounts of data, management of this data becomes increasingly important and complex. The ability to locate information within large data sets through search queries is fundamental in this technology-centric landscape. Some of the data includes text which is searchable, while much of the data may not be searchable. There are, presently, various solutions to make non-searchable documents searchable. However, existing solutions do not maximize efficiency, as the methods perform such that within a particular document, where there are pages that contain non-searchable content, all content on the page, and within every page, of the document must be processed with Optical Character Recognition (OCR), which “recognizes” text characters, creating a separate text record. This often involves creating an entirely new document and increasing the size of the document file.

### SUMMARY OF THE INVENTION

A method including receiving data including first searchable data segments and non-searchable data segments, identifying the non-searchable data segments within the data, determining coordinates for the non-searchable data segments relative to the first searchable data segments, extracting the non-searchable data segments, processing the non-searchable data segments, the processing including converting the non-searchable data segments into second searchable data segments, overlaying the second searchable data segments at the determined coordinates relative to the first searchable data segments and exporting the first searchable data segments and the second searchable data segments.

A system including a processor coupled with a memory, the processor operable to implement a method including receiving data including first searchable data segments and non-searchable data segments, identifying the non-searchable data segments within the data, determining coordinates for the non-searchable data segments relative to the first searchable data segments, extracting the non-searchable data segments, processing the non-searchable data segments, the processing including converting the non-searchable data segments into second searchable data segments, overlaying the second searchable data segments at the determined coordinates relative to the first searchable data segments and exporting the first searchable data segments and the second searchable data segments.

A computer-program product including a non-transitory computer-usable medium having computer-readable program code embodied therein, the computer-readable program code adapted to be executed to implement a method including receiving data including first searchable data segments and non-searchable data segments, identifying the non-searchable data segments within the data, determining coordinates for the non-searchable data segments relative to the first searchable data segments, extracting the non-searchable data segments, processing the non-searchable data segments, the processing including converting the non-searchable data segments into second searchable data segments, overlaying the second searchable data segments at the determined coordinates relative to the first searchable data segments and exporting the first searchable data segments and the second searchable data segments.

### BRIEF DESCRIPTION OF THE DRAWINGS

A more complete understanding of the method and apparatus of the present disclosure may be obtained by reference to the following Detailed Description when taken in conjunction with the accompanying Drawings wherein:

FIG. 1 illustrates an example process for processing data for optical character recognition;

FIG. 2 illustrates an example of a computer system;

FIG. 3 illustrates an example source document;

FIG. 4 illustrates an example normalized export document; and

FIG. 5 illustrates an example of an extracted in-line text document.

### DETAILED DESCRIPTION

Current OCR solutions are often able to locate content that corresponds with a page of a document, which can be broken into box coordinates, but are not able to separate a non-searchable image from within each given page. Thus, current OCR solutions must process all of the data on a page, including the processing of data which is already searchable, herein referred to as “machine-readable text.” Processing of machine-readable text is dependent on the quality of the OCR algorithm, which is oftentimes inferior to the original machine-readable text. The quality and fidelity of the result is most often less than completely accurate. Processing of the entirety of the character data (both within non-searchable image blocks and character data which is already searchable) also changes the nature of the document to a greater, unnecessary degree and, additionally, creates relatively large files.

Modern OCR methods require (1) the ability to separate perceived characters into lines, words, and individual characters and (2) interpretive processing, wherein a language set is determined so that the characters and words can be contextualized, allowing accurate “translation” of the content within an image into readable text. To avoid problems during segmentation which may be caused by distortion in the image, Hidden Markov Models (HMM) are at times employed to prevent error by predicting the sequence of state changes based on a sequence of observations by use of an algorithm tailored to possible textual results given a language set or multiple sets. Prior algorithms include a method whereby after a scan, particular alphanumeric character sets can be separately identified from gray-scale pixel values which are binarized, not requiring the entire “image” to be “recognized.” However, there is not a similar solution for digital documents which are (1) mixed image and machine-readable text, or (2) full-image containing content which will be machine-readable prior to OCR. Currently employed solutions require the entire document page to be processed for any image content to be made machine-readable.

Regardless of pre-processing method, the actual OCR is performed after pre-processing results are received. Current solutions, such as those used by ADOBE or ABBYY FineReader, use the information from pre-processing to determine the most likely characters in entire pages of electronic records, by necessity, overlaying an entire page worth of OCR text information on the corresponding coordinates of the page. This is akin to painting an entire wall where only a touch-up is needed. Thus, in these current solutions, after the “repainting,” it may be an incredibly close representation that may not be noticeable to the naked eye, but it is not actually the real underlying coat of paint being seen. With electronic data, the “underlying coat of paint” has more fidelity, more accuracy, and requires less storage space. As data is ever-expanding over time, storage space, processing power, processing time, fidelity, and accuracy are key.

In accordance with the present disclosure, systems and methods are provided to create searchable electronic documents by identifying and converting non-searchable image blocks into machine-readable text with inline HTML OCR overlay. In accordance with some embodiments, the system and method may identify non-searchable content which is separate from searchable extracted text, determine coordinates of images, convert content in non-searchable image blocks to machine-readable text without altering text which is already searchable, and overlay resulting machine-readable text in the corresponding coordinates of the electronic document.

In accordance with one aspect of the present disclosure, the proposed solution is able to separate non-searchable content from searchable content by locating it within a page separate from the machine-readable text. The proposed solution may include identifying the coordinates within the page that correspond with the non-searchable content, performing OCR on only that non-searchable content, and overlaying the text result based upon those coordinates. This may result in a document that has a much smaller addition in file size, is processed more efficiently and in a scalable manner, while maintaining the quality, fidelity, and character of the document to a greater extent than existing solutions in the prior art. The advantages of this novel solution may include saving time, requiring less processing power, and being more cost-effective than solutions previously provided.

In accordance with the present disclosure, methods and systems for creating searchable electronic documents are provided. In various embodiments, the invention relates to a method and a system which searches for and finds non-searchable image blocks, determines corresponding coordinates, and converts image blocks with non-searchable characters to machine-encoded text without processing text that is already searchable.

In some in embodiment of the proposed solution, various application programing interfaces (APIs) can be utilized, such as, GOOGLE Vision API. GOOGLE Vision API may be utilized for cloud pre-processing, using the information from the resulting JavaScript Object Notation (JSON) payload. In other embodiments, any of a number of pre-processing alternatives could be used in conjunction with the proposed solution. For example, using a microservices architecture, the proposed solution may configure a node layout, scaled according to the amount of and specificities of the data to be processed, (e.g., 4 OCR nodes, 10 PDF nodes, 5 index nodes, 5 expanders, etc.), where each modular service, for example, a virtual machine node, independently performs its configured tasks once assigned. The nodes may be instructed to deploy the specific software packages based on the function assigned, referencing a messaging broker, such as, for example, RABBITMQ, messaged task list to determine units of work to compute. After the box coordinates are determined during pre-processing, the proposed solution utilizes information from a file format API, such as ASPOSE, when overlaying the OCR results over the corresponding areas of images which were previously unsearchable and not machine-readable. The proposed solution may then use the box coordinates information to determine solely what these image areas are on each page, feeding the coordinate information into an HTML template object that is then overlaid on the image area. No OCR method in the current art is able to overlay OCR text on image areas without processing entire pages of information, as no OCR method in the current art utilizes a method of (1) bridging pre-processing to overlay, and (2) template-based overlay to provide a resulting OCR record. While the preferred embodiment is PDF-based, the proposed solution is not reliant upon a particular file or encoding type, and thus may be utilized for any document-based file-types and text encoding.

In one embodiment, a method is provided for creating searchable electronic documents, wherein the method includes executing software commands which locate and determine coordinates of non-searchable image blocks. The method then performs conversion of non-searchable images of typed, handwritten, or printed text into machine-encoded text without altering searchable text in areas outside the image coordinates of a page of the document on which the conversion of non-searchable images into machine-encoded text is to be performed. The method then overlays text resulting from the conversion of non-searchable images of typed, handwritten, or printed text into machine-encoded text of non-searchable image blocks in coordinates of a page within an electronic document corresponding with the determined coordinates, such that text that is searchable before the commands are run is treated separately from non-searchable images so that it is unaltered during the process of conversion of non-searchable images of typed, handwritten, or printed text into machine-encoded text.

In one embodiment, a system is provided for creating searchable electronic documents, wherein the system includes software configured to locate and determine coordinates of non-searchable image blocks. The software may be configured to perform conversion of non-searchable images of typed, handwritten, or printed text into machine-encoded text without altering searchable text in non-image coordinates of a page of the document on which the conversion of non-searchable images into machine-encoded text is to be performed. The software may also be configured to overlay text resulting from conversion of non-searchable images of typed, handwritten, or printed text into machine-encoded text of non-searchable image blocks in coordinates of a page within an electronic document corresponding with the coordinates determined by the software during the steps of locating and determining coordinates of non-searchable image blocks, such that text that is searchable before the software commands are run is treated separately from non-searchable images so that it is unaltered during the process of conversion of non-searchable images of typed, handwritten, or printed text into machine-encoded text.

In one embodiment, a computer-readable medium storing instructions is provided that when executed by a computer causes the computer to create searchable electronic documents. The method includes executing software commands which locate and determine coordinates of non-searchable image blocks; executing software commands which perform conversion of non-searchable images of typed, handwritten, or printed text into machine-encoded text without altering searchable text in non-image coordinates of a page of the document on which the conversion of non-searchable images into machine-encoded text is to be performed; and executing software commands which overlay text resulting from conversion of non-searchable images of typed, handwritten, or printed text into machine-encoded text of non-searchable image blocks in coordinates of a page within an electronic document corresponding with the coordinates determined by the software commands which locate and determine coordinates of non-searchable image blocks, such that text that is searchable before the commands are run is treated separately from non-searchable images so that it is unaltered during the process of conversion of non-searchable images of typed, handwritten, or printed text into machine-encoded text.

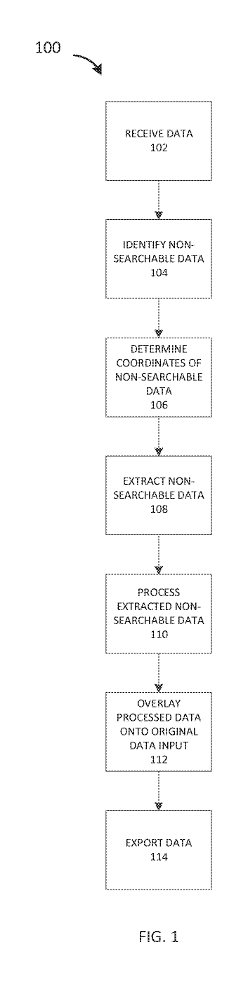

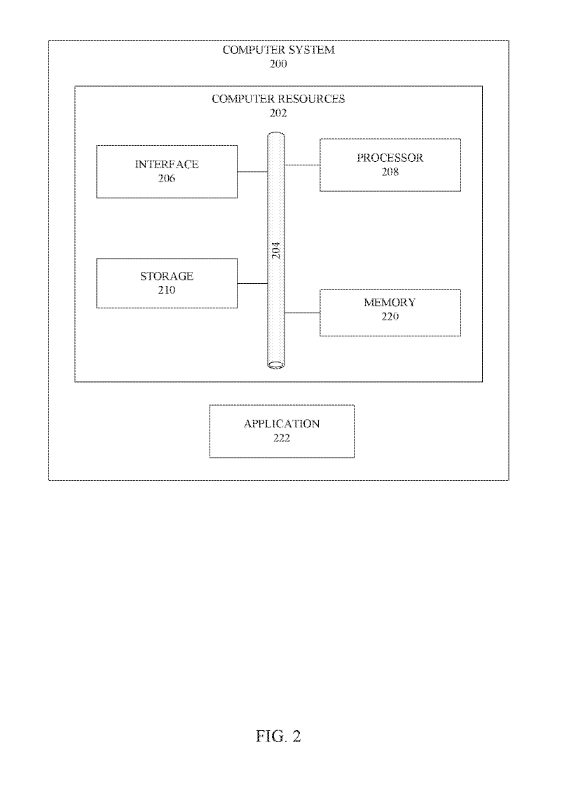

FIG. 1 illustrates an example process 100 for processing data for OCR utilizing the above-disclosed methods. It should be appreciated that, although the process 100 is described as being performed with respect to the generation of OCR data of a single data input, in various embodiments, the process 100 can be repeated, or performed in parallel, for each of a multitude data inputs as set forth below. It should further be appreciated that the process 100 can be performed by a computer system, for example the computer system of FIG. 2, described in further detail below, cloud systems, modules and/or engines running locally or remotely, microservices as described above, or combinations thereof.

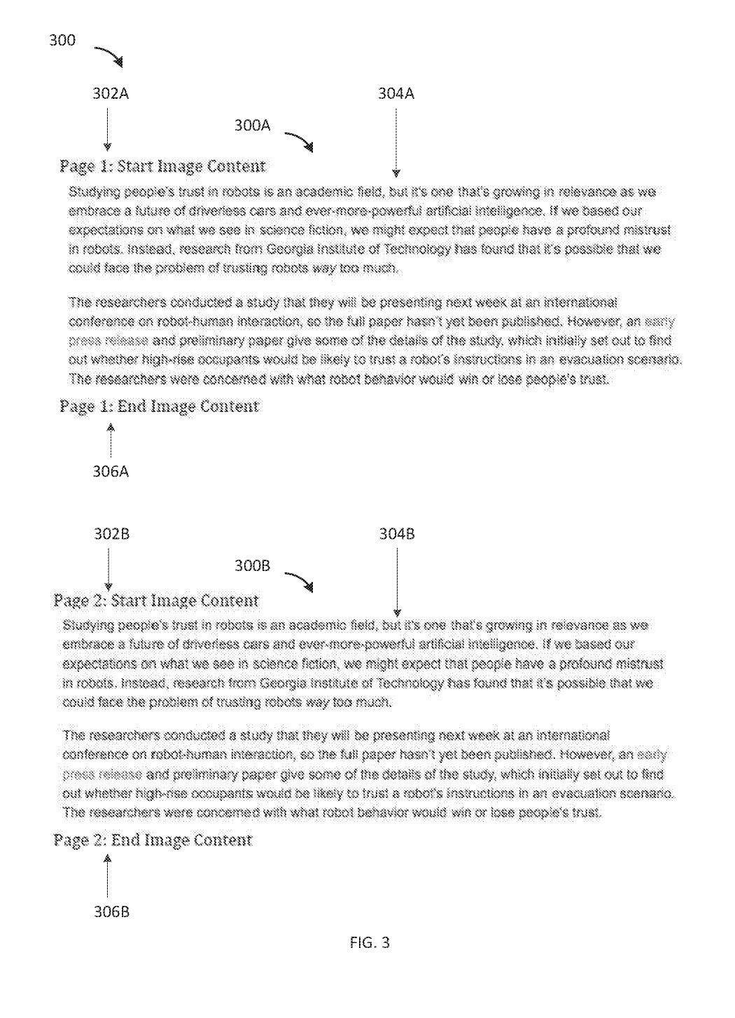

At block 102 a system receives data that can be in the form of uniform-text, images of text, handwritten text or combinations of same and the like. In some embodiments, at block 102, the system can start the process 100 by a trigger being invoked by a user, a request being sent to the system, data being retrieved by the system, data being uploaded to the system or combinations of same and the like. An example of data that can be received at block 102 will be described in fuller detail with regard to FIG. 3. At block 104 the system identifies non-searchable data segments in the received data from block 102. In some embodiments, the non-searchable data segments can include images, handwritten notes, pictures or combinations of same and the like. In various embodiments, if the data does not contain non-searchable data, the process can end, requiring no further processing.

At block 106 the system determines coordinates of the non-searchable data segments within the data. In some embodiments the coordinates can be saved temporarily in system caches and/or data stores within the system for further processing. In certain embodiments, coordinate information can be used to determine solely what areas are on each page, and can feed the coordinate information into an HTML template object that can then be overlaid on the identified area. In some embodiments, the coordinates are isolated using a variety of APIs that can identify and determine machine-readable data and make temporary notations of the location of each segment of the data that is in a non-machine-reading format. Examples of non-searchable data segments within data that contains machine-reachable data will be described further with respect to FIG. 3. At block 108 the system extracts the non-searchable segments from the data for further processing at block 110.

At block 110 the system processes the non-searchable data segments that were extracted at block 108. In various embodiments, the processing can include converting the non-searchable data segments into machine-readable data. The process at block 110 can utilize various OCR technologies, as described above, without altering any information outside of the extracted non-searchable data segments. As such, portions of the data inputted at block 102 that are already in a machine-readable format can go through no additional processing. Only segments identified by the system at block 104 are altered for modification. This enables the process 100 to leave machine-readable data intact, and additionally reduces the computation power required by the system. In some embodiments, the machine-readable data that was not processed retains all of the fidelity and characteristics of the original data. As such, the process 100 can result in highly accurate and clean data without further refinement of previously-identified machine-readable data.

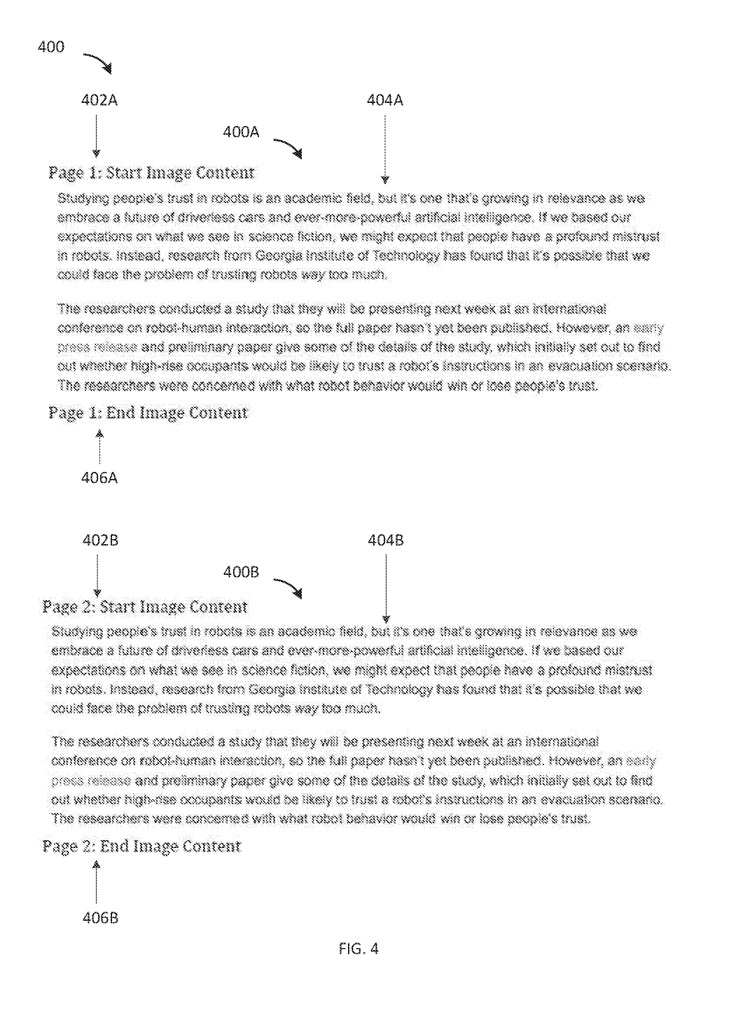

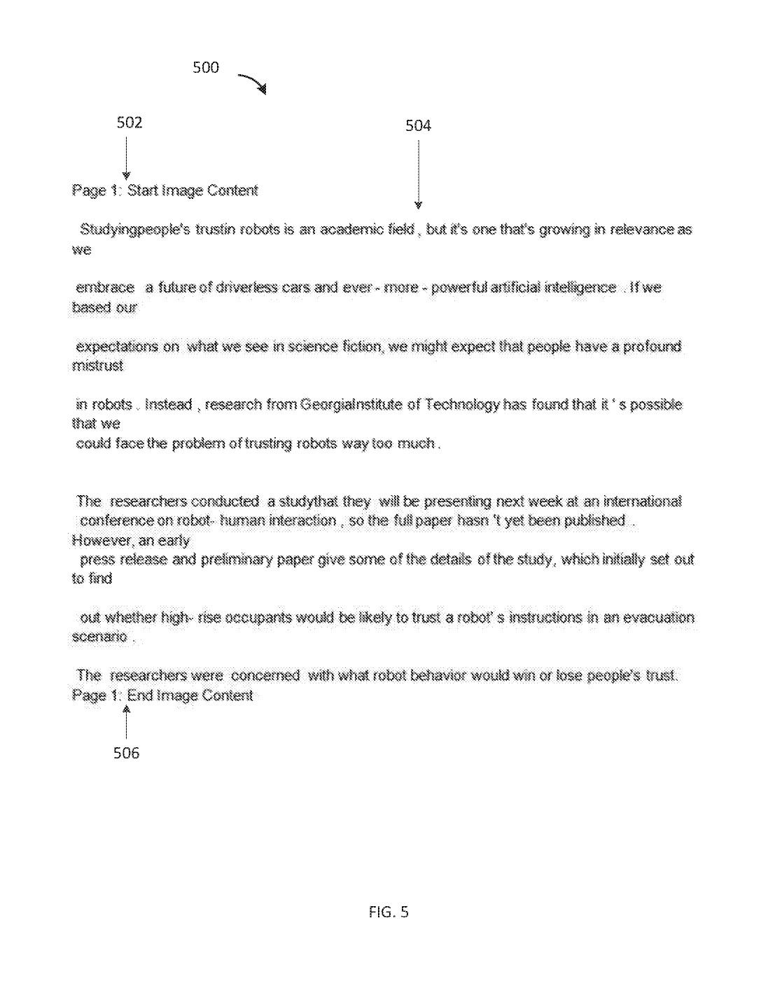

At block 112 the extracted data processed at block 110 is overlaid onto original received data. The coordinates determined at block 106 can be utilized by the system by utilizing information from a file format API, such as ASPOSE, and can be used to overlay the processed data over the corresponding areas of non-searchable data segments. In some embodiments, pre-processing of data can occur during the overlay process. In certain embodiments, coordinate information obtained at block 106 can be used to determine what areas are on each page, and can then be fed into an HTML template object that can then be overlaid on the identified areas. After the overlay at block 112, the process 100 proceeds to block 114. At block 114 the system exports the data in a complete machine-readable datatype. In some embodiments, the export is in a normalized, machine-readable output. An example of the export performed at block 114 utilizing a normalized export will be described in fuller detail with respect to FIG. 4. In some embodiments, the export can be an in-line output file. In various embodiments, the in-line output can be used as an intermediary. An example of the export performed at block 114 utilizing an in-line export will be described in fuller detail with respect to FIG. 5.

FIG. 2 illustrates an example of a computer system 200 that, in some cases, can be representative, for example, of a system for processing data for OCR. The computer system 200 includes an application 222 operable to execute on computer resources 202. The application 222 can be, for example, an application for processing data for OCR, for example the process 100. In particular embodiments, the computer system 200 may perform one or more steps of one or more methods described or illustrated herein. In particular embodiments, one or more computer systems may provide functionality described or illustrated herein. In particular embodiments, encoded software running on one or more computer systems may perform one or more steps of one or more methods described or illustrated herein or provide functionality described or illustrated herein.

The components of the computer system 200 may comprise any suitable physical form, configuration, number, type and/or layout. As an example, and not by way of limitation, the computer system 200 may comprise an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a wearable or body-borne computer, a server, or a combination of two or more of these. Where appropriate, the computer system 200 may include one or more computer systems; be unitary or distributed; span multiple locations; span multiple machines; or reside in a cloud, which may include one or more cloud components in one or more networks.

In the depicted embodiment, the computer system 200 includes a processor 208, memory 220, storage 210, interface 206, and bus 204. Although a particular computer system is depicted having a particular number of particular components in a particular arrangement, this disclosure contemplates any suitable computer system having any suitable number of any suitable components in any suitable arrangement.

Processor 208 may be a microprocessor, controller, or any other suitable computing device, resource, or combination of hardware, software and/or encoded logic operable to execute, either alone or in conjunction with other components, (e.g., memory 220), the application 222. Such functionality may include providing various features discussed herein. In particular embodiments, processor 208 may include hardware for executing instructions, such as those making up the application 222. As an example and not by way of limitation, to execute instructions, processor 208 may retrieve (or fetch) instructions from an internal register, an internal cache, memory 220, or storage 210; decode and execute them; and then write one or more results to an internal register, an internal cache, memory 220, or storage 210.

In particular embodiments, processor 208 may include one or more internal caches for data, instructions, or addresses. This disclosure contemplates processor 208 including any suitable number of any suitable internal caches, where appropriate. As an example and not by way of limitation, processor 208 may include one or more instruction caches, one or more data caches, and one or more translation lookaside buffers (TLBs). Instructions in the instruction caches may be copies of instructions in memory 220 or storage 210 and the instruction caches may speed up retrieval of those instructions by processor 208. Data in the data caches may be copies of data in memory 220 or storage 210 for instructions executing at processor 208 to operate on; the results of previous instructions executed at processor 208 for access by subsequent instructions executing at processor 208, or for writing to memory 220, or storage 210; or other suitable data. The data caches may speed up read or write operations by processor 208. The TLBs may speed up virtual-address translations for processor 208. In particular embodiments, processor 208 may include one or more internal registers for data, instructions, or addresses. Depending on the embodiment, processor 208 may include any suitable number of any suitable internal registers, where appropriate. Where appropriate, processor 208 may include one or more arithmetic logic units (ALUs); be a multi-core processor; include one or more processors 208; or any other suitable processor.

Memory 220 may be any form of volatile or non-volatile memory including, without limitation, magnetic media, optical media, random access memory (RAM), read-only memory (ROM), flash memory, removable media, or any other suitable local or remote memory component or components. In particular embodiments, memory 220 may include random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM, or any other suitable type of RAM or memory. Memory 220 may include one or more memories 220, where appropriate. Memory 220 may store any suitable data or information utilized by the computer system 200, including software embedded in a computer readable medium, and/or encoded logic incorporated in hardware or otherwise stored (e.g., firmware). In particular embodiments, memory 220 may include main memory for storing instructions for processor 208 to execute or data for processor 208 to operate on. In particular embodiments, one or more memory management units (MMUs) may reside between processor 208 and memory 220 and facilitate accesses to memory 220 requested by processor 208.

As an example and not by way of limitation, the computer system 200 may load instructions from storage 210 or another source (such as, for example, another computer system) to memory 220. Processor 208 may then load the instructions from memory 220 to an internal register or internal cache. To execute the instructions, processor 208 may retrieve the instructions from the internal register or internal cache and decode them. During or after execution of the instructions, processor 208 may write one or more results (which may be intermediate or final results) to the internal register or internal cache. Processor 208 may then write one or more of those results to memory 220. In particular embodiments, processor 208 may execute only instructions in one or more internal registers or internal caches or in memory 220 (as opposed to storage 210 or elsewhere) and may operate only on data in one or more internal registers or internal caches or in memory 220 (as opposed to storage 210 or elsewhere).

In particular embodiments, storage 210 may include mass storage for data or instructions. As an example and not by way of limitation, storage 210 may include a hard disk drive (HDD), a floppy disk drive, flash memory, an optical disc, a magneto-optical disc, magnetic tape, or a Universal Serial Bus (USB) drive or a combination of two or more of these. Storage 210 may include removable or non-removable (or fixed) media, where appropriate. Storage 210 may be internal or external to the computer system 200, where appropriate. In particular embodiments, storage 210 may be non-volatile, solid-state memory. In particular embodiments, storage 210 may include read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. Storage 210 may take any suitable physical form and may comprise any suitable number or type of storage. Storage 210 may include one or more storage control units facilitating communication between processor 208 and storage 210, where appropriate.

In particular embodiments, interface 206 may include hardware, encoded software, or both providing one or more interfaces for communication (such as, for example, packet-based communication) among any networks, any network devices, and/or any other computer systems. As an example and not by way of limitation, communication interface 206 may include a network interface controller (NIC) or network adapter for communicating with an Ethernet or other wire-based network and/or a wireless NIC (WNIC) or wireless adapter for communicating with a wireless network.

Depending on the embodiment, interface 206 may be any type of interface suitable for any type of network for which computer system 200 is used. As an example and not by way of limitation, computer system 200 can include (or communicate with) an ad-hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 200 can include (or communicate with) a wireless PAN (WPAN) (such as, for example, a BLUETOOTH WPAN), a WI-FI network, a WI-MAX network, an LTE network, an LTE-A network, a cellular telephone network (such as, for example, a Global System for Mobile Communications (GSM) network), or any other suitable wireless network or a combination of two or more of these. The computer system 200 may include any suitable interface 206 for any one or more of these networks, where appropriate.

In some embodiments, interface 206 may include one or more interfaces for one or more I/O devices. One or more of these I/O devices may enable communication between a person and the computer system 200. As an example and not by way of limitation, an I/O device may include a keyboard, keypad, microphone, monitor, mouse, printer, scanner, speaker, still camera, stylus, tablet, touchscreen, trackball, video camera, another suitable I/O device or a combination of two or more of these. An I/O device may include one or more sensors. Particular embodiments may include any suitable type and/or number of I/O devices and any suitable type and/or number of interfaces 206 for them. Where appropriate, interface 206 may include one or more drivers enabling processor 208 to drive one or more of these I/O devices. Interface 206 may include one or more interfaces 206, where appropriate.

Bus 204 may include any combination of hardware, software embedded in a computer readable medium, and/or encoded logic incorporated in hardware or otherwise stored (e.g., firmware) to couple components of the computer system 200 to each other. As an example and not by way of limitation, bus 204 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCI-X) bus, a serial advanced technology attachment (SATA) bus, a Video Electronics Standards Association local (VLB) bus, or any other suitable bus or a combination of two or more of these. Bus 204 may include any number, type, and/or configuration of buses 204, where appropriate. In particular embodiments, one or more buses 204 (which may each include an address bus and a data bus) may couple processor 208 to memory 220. Bus 204 may include one or more memory buses.

Herein, reference to a computer-readable storage medium encompasses one or more tangible computer-readable storage media possessing structures. As an example and not by way of limitation, a computer-readable storage medium may include a semiconductor-based or other integrated circuit (IC) (such, as for example, a field-programmable gate array (FPGA) or an application-specific IC (ASIC)), a hard disk, an HDD, a hybrid hard drive (HHD), an optical disc, an optical disc drive (ODD), a magneto-optical disc, a magneto-optical drive, a floppy disk, a floppy disk drive (FDD), magnetic tape, a holographic storage medium, a solid-state drive (SSD), a RAM-drive, a SECURE DIGITAL card, a SECURE DIGITAL drive, a flash memory card, a flash memory drive, or any other suitable tangible computer-readable storage medium or a combination of two or more of these, where appropriate.

Particular embodiments may include one or more computer-readable storage media implementing any suitable storage. In particular embodiments, a computer-readable storage medium implements one or more portions of processor 208 (such as, for example, one or more internal registers or caches), one or more portions of memory 220, one or more portions of storage 210, or a combination of these, where appropriate. In particular embodiments, a computer-readable storage medium implements RAM or ROM. In particular embodiments, a computer-readable storage medium implements volatile or persistent memory. In particular embodiments, one or more computer-readable storage media embody encoded software.

Herein, reference to encoded software may encompass one or more applications, bytecode, one or more computer programs, one or more executables, one or more instructions, logic, machine code, one or more scripts, or source code, and vice versa, where appropriate, that have been stored or encoded in a computer-readable storage medium. In particular embodiments, encoded software includes one or more APIs stored or encoded in a computer-readable storage medium. Particular embodiments may use any suitable encoded software written or otherwise expressed in any suitable programming language or combination of programming languages stored or encoded in any suitable type or number of computer-readable storage media. In particular embodiments, encoded software may be expressed as source code or object code. In particular embodiments, encoded software is expressed in a higher-level programming language, such as, for example, C, Perl, or a suitable extension thereof. In particular embodiments, encoded software is expressed in a lower-level programming language, such as assembly language (or machine code). In particular embodiments, encoded software is expressed in JAVA. In particular embodiments, encoded software is expressed in Hyper Text Markup Language (HTML), Extensible Markup Language (XML), or other suitable markup language.

FIG. 3 illustrates an example source document 300. The source document of FIG. 3 can be representative of data that can be received at block 102 of FIG. 1 in regard to the process 100. Functionally, at block 103 of FIG. 1, multiple sets of data may be inputted into the system such that the process 100 can be performed recursively, or in parallel, for each set of data. FIG. 3 illustrates a multipage source document 300 that has been split into two components for simplicity. As the input for each page, in this example, would be described similarly, the description will be described with Page 1 being indicated by the suffix “A” and Page 2 being indicated by the suffix “B.”

In this example, the source document 300 contains two pages, 300A and 300B, which each contain three major components of text containing both machine-readable text and non-searchable text (i.e. non-machine-readable text). 302A and 302B represent machine-readable text within the source documents 300A and 300B, directly above non-searchable text 304A and 304B. Directly below the non-searchable text 304A and 304B is another block of machine-readable text 306A and 306B. While Page 1 is shown having a single block of non-searchable text (304A), the systems and methods described herein may be utilized to identify and process pages having multiple images of non-searchable text with blocks of searchable text interposed therebetween.

In previous processes, OCR methods to convert the non-machine-readable text 304A and 304B would have to convert the entire source document 300 (i.e., both pages 300A and 300B) in order to convert the non-machine-readable text 304A and 304B. In these previous processes, machine-readable text 302A, 302B, 306A and 306B would have to be converted in order to process the non-machine readable text 304A and 304B. The methods described herein, and in particular, the process 100, identify and extract the non-machine-readable text 304A and 304B and thus require no OCR processing of machine-readable text 302A, 302B, 306A and 306B. This allows for the machine-readable text 302A, 302B, 306A and 306B to retain the characteristics of the original format, allow for faster processing of the source document 300 utilizing, for example, the process 100.

In the example presented in FIG. 3, only the non-machine readable text 304A and 304B are extracted and processed. After processing of the non-machine readable text 304A and 304B, the processed data can then be overlaid on an export of the source document 300, which will be described in fuller detail below with regard to FIG. 4. In a preferred embodiment, source document 300 may be in a portable document format (PDF). The PDF document file format can be used to present documents that include text, images, and other elements. A PDF file contains raw document data organized into a tree of objects forming the document catalog. The document catalog contains the information that defines the document's contents and how the document will be displayed on the screen. Each page of a PDF document is represented by a page object, which includes references to the page's contents. By searching the document catalog, object by object, segments of the page where machine-readable text will be displayed can be identified and the location of that text within the page determined. Similarly, images can be identified and the location of those images within the page determined. Oftentimes, the location of an image is defined by the coordinates of the image relative to the area of the entire page, such as the x-y coordinates of all four corners of the image or of a single corner along with a length and height of the image. When an entire page is converted into a single image, the coordinates of any images that may have been contained within that page are no longer needed. By contrast, in order to maintain the original machine-readable text and only OCR images interposed therebetween, the coordinates of each image must be determined and then the location of any text recognized within such image must also be determined. In one embodiment, the coordinates of the location of such text may be established relative to the coordinates of the image, rather than relative to the area of the entire page. For example, in one embodiment, after an image is detected in a page of a document, the x-y coordinates of the top-left and bottom-right corners of the image are determined relative to the area of the entire page. Then, following the OCR process, a location of the recognized text within the image is determined and may be defined relative to a corner of the image. In other embodiments, the location of the recognized text may be determined relative to the coordinate space of the entire page's drawing area.

FIG. 4 illustrates an example normalized export document 400 that contains two pages, 400A and 400B. The normalized export document of FIG. 4 can be representative of data that can be exported at block 114 of FIG. 1 in regard to the process 100. Functionally, block 114 of FIG. 1 can include multiple sets of data to be outputted from the system and the process 100, as such, the process 100 can be performed recursively, or in parallel, for each set of data. FIG. 4 illustrates a normalized export document 400 originating from the source document 300 of FIG. 3 that has been split into two components for simplicity. As the export for each page, in this example, would be described similarly, the description will be described with Page 1 being indicated by the suffix “A” and Page 2 being indicated by the suffix “B.”

The normalized export document 400 contains two pages, 400A and 400B, which each contain portions that resemble 300A and 300B of the source document 300. As can be illustrated in the figure, portions 402A and 402B, 404A and 404B, and 406A and 406B correspond 302A and 302B, 304A and 304B, and 306A and 306B of FIG.3, respectfully. In this particular example, however, the non-machine-readable areas of the portions of 304A and 304B have been processed, for example, by the process 100, to create machine-readable portions 404A and 404B. The machine-readable portions 404A and 404B have been overlaid on their respective positions, relative to source document 300, to create the normalized export document 400. As demonstrated in FIG. 4, the machine-readable portions 404A and 404B have been normalized, with respect to the non-machine-readable portions 304A and 304B of FIG. 3, to generate the normalized export document 400. It should be noted, that this example export document 400 can be subject to the process 100 of FIG. 1 utilizing the source document 300. In this example, portions 402A, 402B, 406A and 406B would not be altered during the process 100. Currently available methods would have required the forgoing portions to be altered before the normalized export document 400 could be generated. In some embodiments, the non-machine-readable sections 304A and 304B can go through the processes expressed in blocks 104, 106, 108 and 110 of FIG. 1 and be positioned on the normalized export document 400 through the process expressed in block 112 of FIG. 1.

FIG. 5 illustrates an example of an extracted in-line text document 500. The in-line text document 500 of FIG. 5 can be representative of data that can be exported at block 114 of FIG. 1 in regard to the process 100, or used as an intermediary. Functionally, block 114 of FIG. 1 allows for multiple sets of data to be outputted from the system, as such, the process 100 can be performed recursively, or in parallel, for each set of data. FIG. 5 illustrates an extracted in-line text document 500 originating from the source document 300 of FIG. 3. For simplicity, only Page 1 (300A) has been reproduced.

As can be seen in FIG. 5, top portion 502 and bottom portion 506 represent the data from 302A and 306A of FIG. 3, while body portion 504 represents the data from 304A of FIG. 3. It should be noted that the top portion 502 and the bottom portion 506 remain unaltered from the source document 300, while the body portion 504 represents data extracted and processed, from the source document 300, specifically the non-machine-readable section 304A of Page 1 (300A). In some embodiments, the non-machine-readable section 304A can go through processes expressed in blocks 104, 106, 108 and 110 of FIG. 1. In various embodiments, the in-line text document 500 can serve as an intermediate document for normalization as expressed with respect to FIG. 4. In various embodiments, the in-line text document is created by extracting the machine readable text from the export document 400 after the machine-readable portion (404A) has been processed and overlaid. In such embodiments, the application used to extract the machine readable text would scan the page and extract all the machine-readable text (i.e., 402A, 404A, and 406A). In addition to extracting the text to create in-line text document 500, various embodiments may also add the text to a search repository to facilitate document searching.

Depending on the embodiment, certain acts, events, or functions of any of the algorithms described herein can be performed in a different sequence, can be added, merged, or left out altogether (e.g., not all described acts or events are necessary for the practice of the algorithms). Moreover, in certain embodiments, acts or events can be performed concurrently, e.g., through multi-threaded processing, interrupt processing, or multiple processors or processor cores or on other parallel architectures, rather than sequentially. Although certain computer-implemented tasks are described as being performed by a particular entity, other embodiments are possible in which these tasks are performed by a different entity.

Conditional language used herein, such as, among others, “can,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

While the above detailed description has shown, described, and pointed out novel features as applied to various embodiments, it will be understood that various omissions, substitutions, and changes in the form and details of the devices or algorithms illustrated can be made without departing from the spirit of the disclosure. As will be recognized, the processes described herein can be embodied within a form that does not provide all of the features and benefits set forth herein, as some features can be used or practiced separately from others. The scope of protection is defined by the appended claims rather than by the foregoing description. All changes which come within the meaning and range of equivalency of the claims are to be embraced within their scope.

Although various embodiments of the method and apparatus of the present invention have been illustrated in the accompanying Drawings and described in the foregoing Detailed Description, it will be understood that the invention is not limited to the embodiments disclosed, but is capable of numerous rearrangements, modifications and substitutions without departing from the spirit of the invention as set forth herein.

What is claimed is:

1. A method comprising:
receiving a source document having a layout comprising a plurality of objects disposed at locations in the source document;
searching the plurality of objects to identify objects corresponding to non-searchable images and objects corresponding to searchable text;
determining coordinates for the locations of the non-searchable images;
generating text representations of text that is included in the non-searchable images utilizing a character recognition application;
correlating position data of the text representations with locations of corresponding text in the non-searchable images;
rendering the source document for display overlaid with the text representations displayed in an overlay over the source document, the text representations visually replacing the non-searchable images in the display; and
storing the source document and the text representations in a single file.

2. The method of claim 1 and further comprising generating a markup document that includes the text representations and the searchable text, wherein the text representations are in-line with the searchable text.

3. The method of claim 2, wherein the markup document is generated by extracting the text representations from the overlay and extracting the searchable text from the source document after generation of the text representations.

4. The method of claim 1, wherein the overlaying comprises utilizing inline hypertext markup language (HTML) OCR overlay.

5. The method of claim 4, wherein the overlaying comprises feeding the determined coordinates for the non-searchable data segments into an HTML template object.

6. The method of claim 1, wherein the non-searchable data segments comprise at least one of images of typed text, handwritten text and printed text.

7. The method of claim 1 and further comprising searching the searchable text in the source document and the text representations in the overlay.

8. The method of claim 1, wherein the source document is one of an HTML file, a PDF file, or a native word processing application file.

9. The method of claim 1 and further comprising:
receiving a text search request for selected text;
initiating a text search for the selected text in the searchable text and the text representations; and
returning search results identifying the locations g to the selected text.

10. The method of claim 1, wherein the coordinates of the locations of the non-searchable images are determined relative to a page area of the source document and the position data of the text representations are correlated relative to the coordinates of the non-searchable images.

11. A method comprising:
receiving a source document having a layout comprising a plurality of objects disposed at locations in the source document;
searching the plurality of objects to identify objects corresponding to non-searchable images and objects corresponding to searchable text;
determining coordinates for the locations of the non-searchable images;
processing the non-searchable images by performing an optical character recognition process on the non-searchable images to recognize text within the non-searchable images;
creating an overlay containing the recognized text disposed at positions corresponding to the locations of the non-searchable images from which the text was recognized;
modifying the source document to include the overlay, wherein the modified source document visually replicates the source document when displayed on a display device;
storing the modified source document; and
extracting the machine readable text from the modified source document to create a markup document containing the searchable text in-line with the recognized text.

12. The method of claim 11, wherein the markup document is generated by extracting the text representations from the overlay and extracting the searchable text from the source document after generation of the text representations.

13. The method of claim 11, wherein the overlaying comprises utilizing inline hypertext markup language (HTML) OCR overlay.

14. The method of claim 11 and further comprising creating an HTML template object having data segments corresponding to the determined coordinates of the locations of the non-searchable data images.

15. The method of claim 11, wherein the source document is one of an HTML file, a PDF file, or a native word processing application file.

16. A computer-program product comprising a non-transitory computer-usable medium having computer-readable program code embodied therein, the computer-readable program code adapted to be executed to implement a method comprising:
receiving a source document comprising a document page containing first searchable data segments and non-searchable data segments;
identifying the non-searchable data segments within the document page;
determining coordinates for the non-searchable data segments relative to the document page;
extracting the non-searchable data segments;
processing the non-searchable data segments, the processing comprising converting the non-searchable data segments into second searchable data segments;
overlaying the second searchable data segments at the determined coordinates; and
saving the document page comprising the first searchable data segments and the second searchable data segments.

17. The computer-program product of claim 16, wherein the converting comprises optical character recognition (OCR) processing.

18. The computer-program product of claim 16, wherein the overlaying comprises utilizing inline hypertext markup language (HTML) OCR overlay.

19. The computer-program product of claim 18, wherein the overlaying comprises feeding the determined coordinates for the non-searchable data segments into an HTML template object.

20. The computer-program product of claim 16, wherein the source document is one of an HTML file, a PDF file, or a native word processing application file.
